(19) United States
(12) Patent Application Publication
(10) Pub. No.: US 2016/0000649 A1
(43) Pub. Date: Jan. 7, 2016

(54) DISPENSER

(71) Applicant: SANOTACT (HK) LIMITED, TST East, KLN, Hong Kong (CN)

(72) Inventor: Henry Albrecht Callaghan, Hong Kong (CN)

(73) Assignee: sanotact (HK) Limited, TST East, KLN, Hong Kong (CN)

(21) Appl. No.: 14/769,579

(22) PCT Filed: Feb. 24, 2014
(86) PCT No.: PCT/IB2014/000198

§ 371 Date: Aug. 21, 2015

(30) Foreign Application Priority Data
Feb. 22, 2013 (DE) 10 2013 101 764.9

(51) Int. Cl. A61J 1/03; B65D 43/26; B65D 43/16

(52) U.S. Cl. CPC A61J 1/03; B65D 43/16; B65D 43/26; B65D 2543/00277; B65D 2543/00296

(57) ABSTRACT

A dispenser (1), especially for edible pills, comprising a housing (2) in which a chamber is provided for accommodating a plurality of pills, wherein a pushbutton (3) is arranged on the housing (2), said pushbutton being pre-tensioned via at least one spring (31) to a starting position, and an output opening (4) arranged in the housing (2) which can be closed via a closure element (10), wherein the closure element (10) is pivotable by pressing the pushbutton (4) in order to release the output opening (4) at least in part. A pill can thus be discharged from the dispenser in a simple manner by actuating the pushbutton (3).

### BACKGROUND OF THE INVENTION

1. Field of the Invention

The present invention relates to a dispenser, especially for edible pills, comprising a housing in which a chamber is provided for accommodating a plurality of pills, wherein a pushbutton is arranged on the housing, which is pre-tensioned via at least one spring to a starting position, and an output opening arranged in the housing which can be closed via a closure element.

2. Description of Related Art

U.S. Pat. No. 2,722,309 discloses a dispenser for pills, in which a slide is provided in a box-shaped housing, which slide is displaceable in order to release on output opening. The slide can then be brought to a closed position after the removal of the pill. The actuation of such a slide is comparatively laborious because it can easily get jammed due to frictional forces and the narrow handle section needs to be touched precisely by the finger. Actuation with only one hand is often very difficult, and the slide further needs to be displaced in the opening direction and also in the closing direction.

### SUMMARY OF THE INVENTION

It is therefore the object of the present invention to provide a dispenser which avoids the above problems and is easy to actuate.

This object is achieved by a dispenser with the features described herein.

In accordance with the invention, the dispenser comprises a pushbutton on the housing, by means of which the closure element is pivotable by pressing in order to release the output opening at least in part, so that one or several pills can be removed. After the pressing of the pushbutton, the pushbutton can be moved back to the starting position again by way of the at least one spring, so that the output opening is automatically closed again via the closure element. Consequently, the user only needs to apply the force for pressing the pushbutton for the opening process, while the closing process occurs automatically by the spring, which facilitates actuation. Furthermore, the pushbutton can simply be actuated by pressing, without said pushbutton being capable of jamming along a longer path of displacement.

According to a preferred embodiment, the closure element is rotatably mounted about an axis. The axis can be arranged in a middle region of the housing, especially in the region of the pushbutton.

A helix-shaped curve guide is preferably provided for actuating the closure element via the pushbutton in order to transmit a translatory (linear) movement of the pushbutton into a rotational movement of the closure element. The closure element is twisted in an opposite direction during a movement of the pushbutton to the starting position.

A guide web is preferably provided on the housing, by means of which the pushbutton is movably guided in the direction of movement, but in a torsion-proof way so that the pushbutton will not rotate during a linear movement. It is ensured in this manner that when the pushbutton is pressed no undesirable rotational movement will occur which would cause frictional forces between the pressing finger and the pushbutton and which allows smooth actuation.

A rotatable drive element is preferably provided around the guide web, which drive element comprises a helix-shaped curve guide. A radially protruding extension arm with a closure element arranged as a closure flap can be provided on the drive element. As a result, the dispenser can be produced with only few components, e.g., only the pushbutton and that the drive element with the closure flap can be provided in addition to the housing, so that only two parts are required in addition to the housing.

The closure element is curved according to the adjacently arranged housing for a visually appealing configuration. The housing can be arranged in the manner of a shell for example having an arc-shaped circumferential curvature, and when the outlet opening is arranged on the outer circumference both the output opening and also the closure element can be arranged in a respectively curved manner.

The housing is substantially arranged in a circular way when seen in a top view, wherein the pushbutton is arranged concentrically in the housing. The pushbutton can be arranged on a first housing part, whereas the output opening is provided on an opposite second housing part. The output opening can be arranged in an offset manner radially in relation to the pushbutton, so that an actuating mechanism can be housed in a simple way in the housing for the closure element.

The dispenser can be used to dispense pills such as sweets, coated tablets, chocolate, candy, tablets or other solid bodies, depending on the size of the housing and the outlet opening.

The invention will be explained below in closer detail by reference to an embodiment shown in the enclosed drawings.

### BRIEF DESCRIPTION OF THE DRAWINGS

FIG. 1 shows a perspective view of a dispenser in accordance with the invention;

FIG. 2 shows a bottom view of the dispenser of FIG. 1;

FIGS. 3A and 3B show two views of a bottom housing part of the dispenser of FIG. 1;

FIGS. 4A to 4D show several views of the pushbutton of the dispenser of FIG. 1, and

FIGS. 5A to 5E show several views of the closure element and the drive element of the dispenser of FIG. 1.

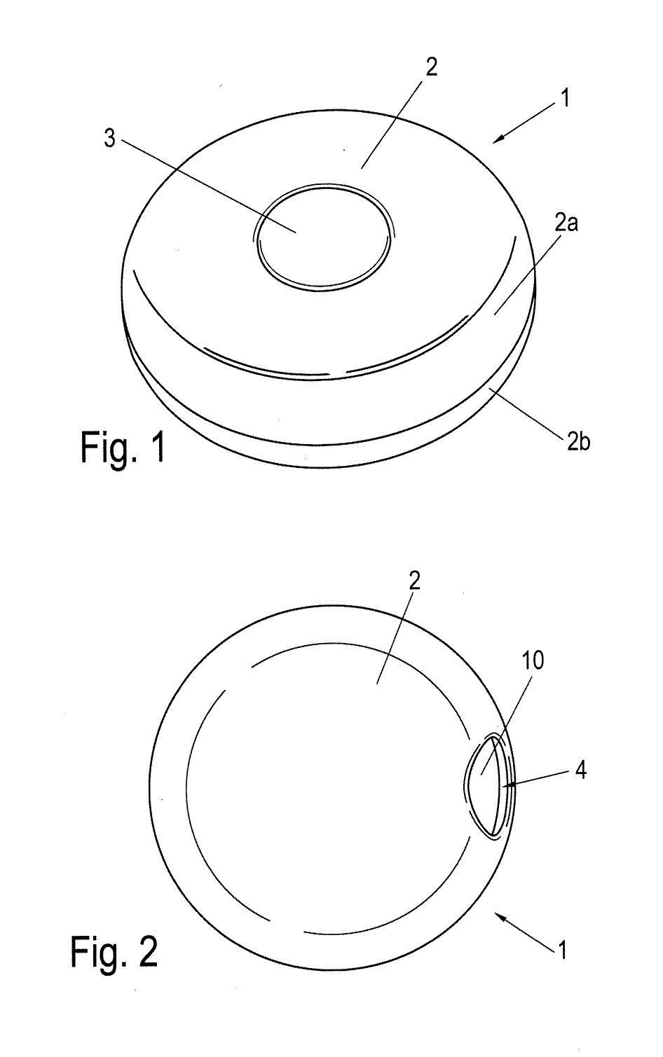

### DETAILED DESCRIPTION OF THE INVENTION

A dispenser 1 comprises a housing 2 which is substantially circular in the top view, wherein the housing 2 can also have any other geometrical shape and can be cuboid, spherical or cubical. A pushbutton 3 is arranged substantially concentrically in a middle region of a surface of the housing 2, which pushbutton is movably guided in the pressing-in direction in a first housing part 2a. A second housing part 2b is arranged on the side facing away from the first housing part 2a, on which an output opening 4 is provided which is closable via a closure element 10. The output opening 4 is arranged off-center in a circumferential region of the housing 2. One or several pills can be output from a chamber within the housing 2 by releasing the output opening 4 when the pushbutton 3 has moved the closure element 10 from the closed position by pressing said pushbutton.

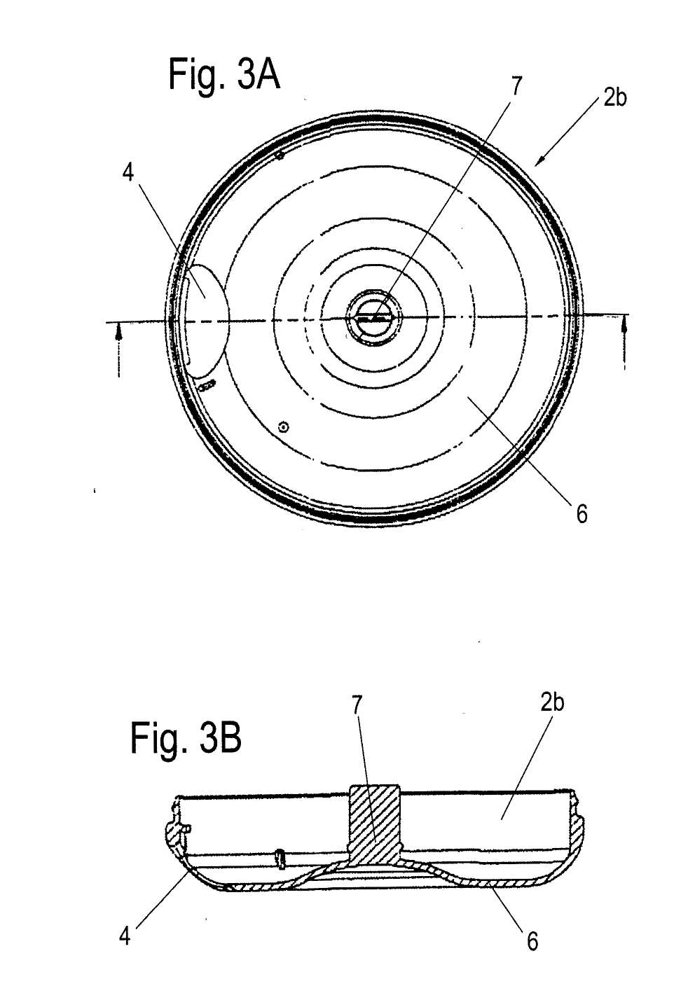

FIGS. 3A and 3B show the bottom housing part 2b which is arranged in the manner of a shell and comprises the output opening 4 on a base 6 adjacent to an outer edge. A guide web is provided as a guide element 7 in a middle region of the base 6, which guide web protrudes into an interior space of the housing part 2b and is used for guiding the pushbutton 3. The guide web has a rectangular cross section, so that the pushbutton 3 is guided in a displaceable but also rotation-proof manner.

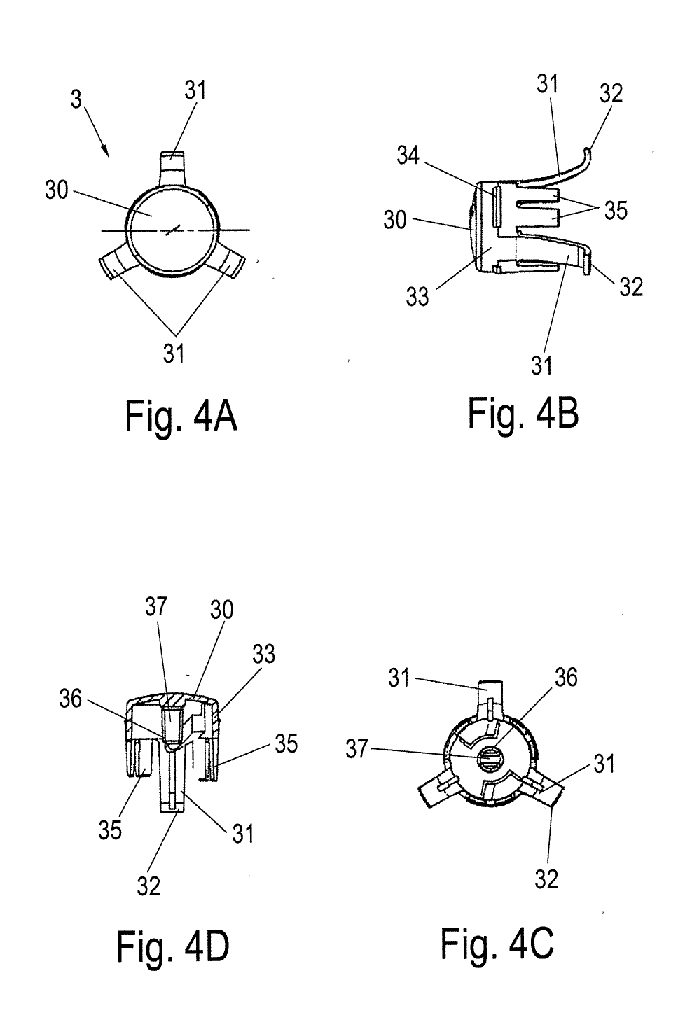

The pushbutton 3 is shown in detail in FIGS. 4A to 4D. The pushbutton 3 comprises a curved surface 30 which is visible from the outside and can be actuated via a finger in order to press the pushbutton 3 into the housing 2. An annular wall section 33 is provided adjacent to the curved surface 30 which is arranged for lateral guidance within an opening on the upper housing part 2a.

Three spring webs 31 are arranged integrally with the pushbutton 3, which spring webs comprise a bent foot section 32. The bent foot section 32 rests on the base 6 of the housing part 2b. When the pushbutton 3 is pressed inwardly, the foot sections 32 slide along the base 6 radially to the outside and bend the spring web 31 accordingly. This leads to a restoring force by the spring webs 31 when the pushbutton 3 is pressed in, which spring webs ensure that the pushbutton is moved back to a starting position after the completed actuation.

Projections 34 are further provided on the pushbutton 3 on the wall section 33, which projections cooperate with a stop on the housing part 2a, so that the maximum movement of the pushbutton 3 to the outside is limited. It is thus prevented that the pushbutton 3 can detach from the housing 2.

Webs 35 for actuating a drive element are further provided on the pushbutton 3. The webs 35 are provided in extension of the wall section 33.

A guide section 36 is further provided in a middle region of the pushbutton 3, in which a slit 37 is arranged. The slit 37 is used for accommodating the web-shaped guide element 7 on the bottom housing part 2b, so that the pushbutton 3 is guided in a displaceable but torsion-proof manner on the guide element 7 by inserting the guide element 7 into the slit 37.

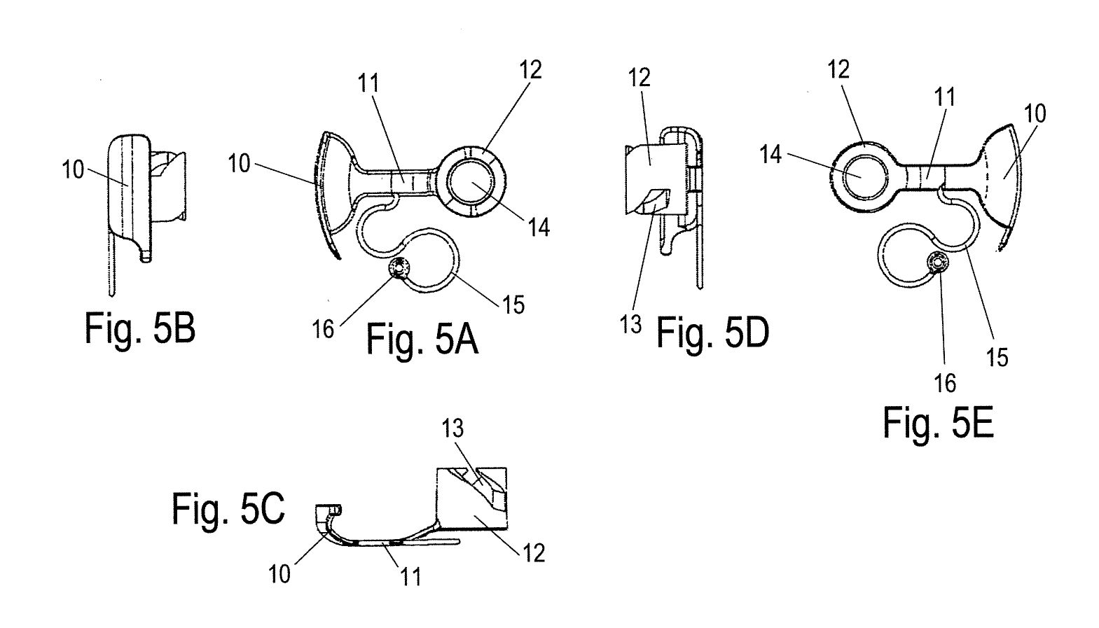

FIGS. 5A to 5E show the closure element 10 with a drive element 12 which is integrally arranged, e.g., as an injection-molded part made of plastic. The closure element 10 is arranged as a closure flap, which can be arranged according to the curvature of the housing 2b in the region adjacent to the output opening 4, so that the closure element can be arranged in an angular or arc-shaped manner. The closure element 10 for covering the output opening 4 is held on a lever-shaped extension arm 11 which is connected to the drive element 12.

The drive element 12 is arranged as a sleeve having an inner opening 14 which is arranged around the guide element 7 on the bottom housing part 2b and is rotatably mounted there. A helix-shaped curve guide 13 is arranged on the sleeve of the drive element 12 on the outside, into which the webs 35 of the pushbutton 3 engage. By pressing the pushbutton 3, the webs 35 are pressed into the helix-shaped groove-like curve guide 13 on the drive element 12, so that it is rotated about the axis which forms the opening 14 together with the guide element 7. The closure element 10 thus pivots as a result and releases the output opening 4 at least in part.

A shaking element 15 in form of a bent web with an end 16 is arranged in the region of the extension arm 11. The shaking element 15 ensures during the pivoting of the closure element 10 that the pills within the housing 2 will not obstruct the movement of the closure element 10, and if the pills nevertheless obstruct the path of movement of the closure element 10 the closure element 10 is left in the closed position so that the user can shake the housing 2 at first in order to enable the removal of the pills again after the actuation of the closure element 10. The shaking element 15 with the end 16 can optionally also be omitted.

In the illustrated embodiment, the housing, the pushbutton and the closure element 10 can be made of plastic. It is also possible to produce parts of the dispenser 1 of metal, e.g. the housing part 2a and/or the housing part 2b. The pushbutton 3 can also be provided with a cap made of metal, which provides a more high-quality appeal.

A helix-shaped curve guide is provided in the illustrated embodiment on the drive element 12. It is obviously also possible to provide the helix-shaped curve guide 13 on an inner circumference of the sleeve or to transmit a translatory movement of the pushbutton 3 to a pivoting movement of the closure element 10 via a different drive mechanism.

The dispenser in accordance with the invention is especially suitable for sweets, especially candy, coated tablets, chocolate or other edible pill-shaped elements. The dispenser can also be tilted or shaken by the user when dispensing the elements, so that jamming does not present any problems in the removal process.

In the illustrated embodiment, the spring webs 31 are used as a spring in order to pretension the pushbutton 3 to a starting position. It is obviously also possible to provide any other spring element, e.g., a helical spring, which is arranged within the pushbutton 3 in order to pretension the pushbutton to a specific starting position.

What is claimed is:

1. A pill dispenser (1), comprising a housing (2) in which a chamber is provided for accommodating a plurality of pills, wherein a pushbutton (3) is arranged on the housing (2), which is pretensioned via at least one spring (31) to a starting position, and an output opening (4) arranged in the housing (2) which can be closed via a closure element (10), characterized in that the Closure element (10) is pivotable by pressing the pushbutton (4) in order to release the output opening (4) at least in part.

2. A dispenser according to claim 1, characterized in that the closure element (10) is mounted to be rotatable about an axis (14).

3. A dispenser according to claim 1, characterized in that a helix-shaped curve guide (13) is provided between the pushbutton (3) and the closure element (10) in order to transfer a translatory movement of the pushbutton (3) into a rotational movement of the closure element (10).

4. A dispenser according to claim 1, characterized in that a guide element (7) is provided on the housing (2), by means of which the pushbutton (3) is movable in a torsion-proof manner in a linear direction of movement.

5. A dispenser according to claim 4, characterized in that a rotatable drive element (12) with a helix-shaped curve guide (13) is arranged around the guide web (7).

6. A dispenser according to claim 5, characterized in that a closure flap is arranged as a closure element (10) on the drive element (12) on a radially protruding extension arm (11).

7. A dispenser according to claim 1, characterized in that the closure element (10) is adjacently arranged with respect to the housing and is curved according to the housing (2).

8. A dispenser according to claim 1, characterized in that the housing (2) is arranged substantially circularly in a top view, and the pushbutton (3) is arranged concentrically in the housing (2).

9. A dispenser according to claim 1, characterized in that the housing (2) comprises a first housing part (2a) with the pushbutton (3) and a second housing part (2b) with the output opening (4).

10. A dispenser according to claim 1, characterized in that the housing (2) is made of metal and/or plastic.
